(19) United States
(12) Patent Application Publication
(10) Pub. No.: US 2025/0175515 A1
(43) Pub. Date: May 29, 2025

(54) CitzVoice

(71) Applicant: Collins Yazenga Mkandawire, Rome, GA (US)

(72) Inventor: Collins Yazenga Mkandawire, Rome, GA (US)

(21) Appl. No.: 18/519,048

(22) Filed: Nov. 26, 2023

(51) Int. Cl. H04L 67/02; G06Q 50/00; G06Q 50/22

(52) U.S. Cl. CPC H04L 67/02; G06Q 50/01; G06Q 50/22

(57) ABSTRACT

CitzVoice (Citizens' Voice) Progressive Web Application used by the citizens to reach out to their representatives and vice versa. It is a tool to get action, reaction, information, civic education, etc. on all matters pertaining to citizens' well-being in their constituencies and indeed the Nation. Users can reach out to their representatives in their County, State, and Nation via the app. They can post comments, pictures, videos to the attention of their representatives and other users. Users can voice opinions on the app on policies, elections, the economy, etc. and enjoy general day-to-day personal or group occurrences. Automatically built into the application are linkages to the offices of Members of Congress, Senators, and Governments (Federal, State, and Local). User eligibility is restricted to Citizens registered to vote, Legal citizens not registered to vote, Representatives, Political Parties, Donors, Lobbyists, Government, Corporations, and organizations.

CitzVoice (Citizens' Voice) Progressive Web Application (PWA) had a provisional patent filled Dec. 26, 2022.

Application No. 63/435,290

EFS ID Number: 47273601

### BACKGROUND OF THE INVENTION

### (1) Field of the Invention: Social Media

### (2) Description of Related Art Including Information Disclosed Under 37 CFR 1.97 and 1.98

### BRIEF SUMMARY OF THE INVENTION

CitzVoice is (Citizens' Voice) Progressive Web Application used by the citizens to reach out to their representatives and vice versa. Users can reach out to their representatives in their County, State, and Nation via the app. They can post comments, pictures, videos to the attention of their representatives and other users. Users can voice opinions on the app on policies, elections, the economy, etc. and enjoy general day-to-day personal or group occurrences. Automatically built into the application are linkages to the offices of Members of Congress, Senators, and Governments (Federal, State, and Local).

### DETAILED DESCRIPTION OF THE INVENTION

### CitzVoice (Citizens' Voice) Progressive Web Application (PWA)

An application used by the citizens (electorates or constituents) to reach out to their representatives and vice versa. The application is a tool to get action, reaction, information, civic education, etc. on all matters pertaining to the citizens' well-being in their constituencies and indeed the Nation.

### Why CitzVoice:

Vibrant engagement—most constituents do not know what their representatives are doing as regards representing them. This application links the representative to the constituents and vice versa. This application links government (Federal, State, Local, etc.) and the constituents.
Accurate information—48% of 18-29-year-olds get most of their political information from social media and there is a need for accurate information that can come from the representatives to the constituents and vice versa.
It is important to have such an app in order to remove distrust between the government, the representatives, and the citizens.
In this time and age, we cannot rely on information coming from third parties when the information can come straight from interested parties, and/or concerned parties directly.
In democracies elections are used to understand what the electorates want, this time around we will be able to know what the electorates want in real-time. So that general elections can be won by candidates that are aligned with their electorate and indeed the citizens.

### Application User Eligibility:

Automatically built into the application are the linkages to the offices of Members of Congress, Senators, Lords, and Governments (Federal, State, and Local).
Citizens registered to vote.
Legal citizens but not registered to vote.
Members of Congress and Senators (Federal, State, Local) in US. While in other countries—Members of Parliament, House of Lords, etc.
Political Parties
Donors
Lobbyists
Governments (Federal, State, Local, etc.)
Corporations or companies
Not-for-profit organizations

CitzVoice is an app that allows users to look up their city, county, state, and federal representatives. They can leave comments, pictures, videos on the app that can be viewed by other users that are in their respective areas. This application is a place for people to learn about their local, state, and federal policies, leave comments and voice opinions online about those policies and enjoy general day-to-day personal or group occurrences.

1. CitzVoice is the name of Progressive Web Application, used by the citizens to reach out to their representatives and vice versa.

2. CitzVoice as in claim 1 wherein said is a tool to get action, reaction, information, civic education, etc. on all matters pertaining to citizens' well-being in their constituencies and indeed the Nation.

3. Citizens as in claim 2 wherein said are users, can reach out to their representatives in their County, State, and Nation via the app, post comments, pictures, videos to the attention of their representatives and other users within their areas and indeed the Nation. They can voice opinions on the app on policies, elections, the economy, etc. and enjoy general day-to-day personal or group occurrences.

4. CitzVoice as in claim 1 wherein said a Progress Web Application has automatically built in linkages to the offices of Members of Congress, Senators, and Governments (Federal, State, and Local).

5. Users as in claim 3 wherein said are Citizens registered to vote, Legal citizens not registered to vote, Representatives, Senators, Political Parties, Donors, Lobbyists, Government (Federal State, and Local), Corporations, and organizations.
